(19) United States
(12) Patent Application Publication
(10) Pub. No.: US 2013/0048104 A1
(43) Pub. Date: Feb. 28, 2013

(54) WATER SAVING TANK

(71) Applicant: I-Fan Li, Taichung City (TW)

(72) Inventor: I-Fan Li, Taichung City (TW)

(21) Appl. No.: 13/214,639

(22) Filed: Aug. 22, 2011

(51) Int. Cl. F16K 21/18

(52) U.S. Cl. 137/386

(57) ABSTRACT

A water saving tank includes a tank box and a supplementary device. The tank box includes an inlet, a supplementary port and an outlet. The inlet collects the water from a shower head, the supplementary port connects to an exterior water source, and the outlet connects to a fill device in a cistern of a water closet. A position level of the tank box is higher than that of the cistern of the water closet. The supplementary device joints to the supplementary port; as the water in the tank box drops to a first predetermined water level, the water of the exterior water source flows into the tank box; as the water in the tank box is filled up to a second predetermined water level, the water of the exterior water source is blocked to flow into the tank box. The water is saved effective thereby and further is able to be reserved for spared.

### BACKGROUND OF THE INVENTION

(1) Field of the Invention

The present invention relates to the water saving mechanism, in particular, to a water saving tank with great efficiency.

(2) Description of the Prior Art

As taking a shower, the water is generally heated up by a heater and delivered to a shower head. For safety or some specific functions, the water heater, no matter the gas one, electrical one or the solar one, is mostly installed at the distant outdoors, such as balcony or top floor. When taking the shower, the cold water in the transportation pipes is usually drained out to induce the hot water, and maybe it takes a while because there is a longer wait to obtain hot water. People drain off the cold water or the water which is not warm enough, until the water temperature has been appropriate, and start to take shower. However, it wastes lots of water. Especially, while using soap or shower gel or cleaning different parts, to break down the showering is usually happened. The inconsistent watering makes the water heater more often to warm up the water or to adjust the temperature of the water, which takes longer wait. People keep the shower head watering to avoid the wait due to the previous situation, and it results in further waste of water resource.

### SUMMARY OF THE INVENTION

In view of the aforementioned issues, a water saving tank, which is advantaged of effective conservation of the water source, is disclosed.

To achieve the above-mentioned objectives, the present invention provides a water saving tank, which includes a tank box, and a supplementary device. The tank box includes an inlet, a supplementary port and an outlet. The inlet collects the water from a shower head, the supplementary port connects to an exterior water source, and the outlet connects to a fill device in a cistern of a water closet. A position level of the tank box is higher than that of the cistern of the water closet. The supplementary device joints to the supplementary port; as the water in the tank box drops to a first predetermined water level, the water of the exterior water source flows into the tank box; as the water in the tank box is filled up to a second predetermined water level, the water of the exterior water source is blocked to flow into the tank box.

Therefore, the tank box is capable of collecting the water from the shower head, which maybe cold water at the very beginning, water started to be warmed up, or hot water at the desired temperature. The water collected in the tank box can be applied for the cistern of the water closet, a sink, a faucet or any water source the like, so that the water is prevented to be wasted and is further reserved. In addition, the supplementary device is used for keeping the tank box at the second predetermined water level, in order to guarantee the water inside the tank box to be sufficient for the water closet, the sink or the faucet.

Preferably, the water saving tank further includes a water collection funnel, a clamping fixture, and a temperature sensor; the water collection funnel connecting to the inlet of the tank box; the clamping fixture engaging the shower head to a predetermined position for forwarding the water from the shower head to water collection funnel. The temperature sensor is disposed to the water collection funnel for detecting the temperature of the water from the shower head, so that the user can know whether the water meet the required temperature. Thus, the water collection from the shower head is more efficient and effective.

The supplementary device includes a inlet pipe, a water supply valve, and a float ball; a bottom end of the inlet pipe connects the supplementary port, the water supply valve joints with a top end of the inlet pipe for controlling whether the water of the inlet flows into the tank box; the float ball connects the water supply valve for switching the water supply valve.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is an illustration of a first embodiment of a water saving according to the present invention;

FIG. 2 is an illustration of the first embodiment of the water saving tank showing the water collection for the shower head;

FIG. 3 is an illustration of the first embodiment of the water saving tank showing automatic water filling according to the present invention;

FIG. 4 is an illustration of the first embodiment of the water saving tank operated with the water closet;

FIG. 5 is an illustration of a second embodiment of the water saving according to the present invention;

FIG. 6 is an illustration of a third embodiment of the water saving according to the present invention; and

FIG. 7 is an illustration of a fourth embodiment of the water saving according to the present invention.

### DETAILED DESCRIPTION OF THE PREFERRED EMBODIMENTS

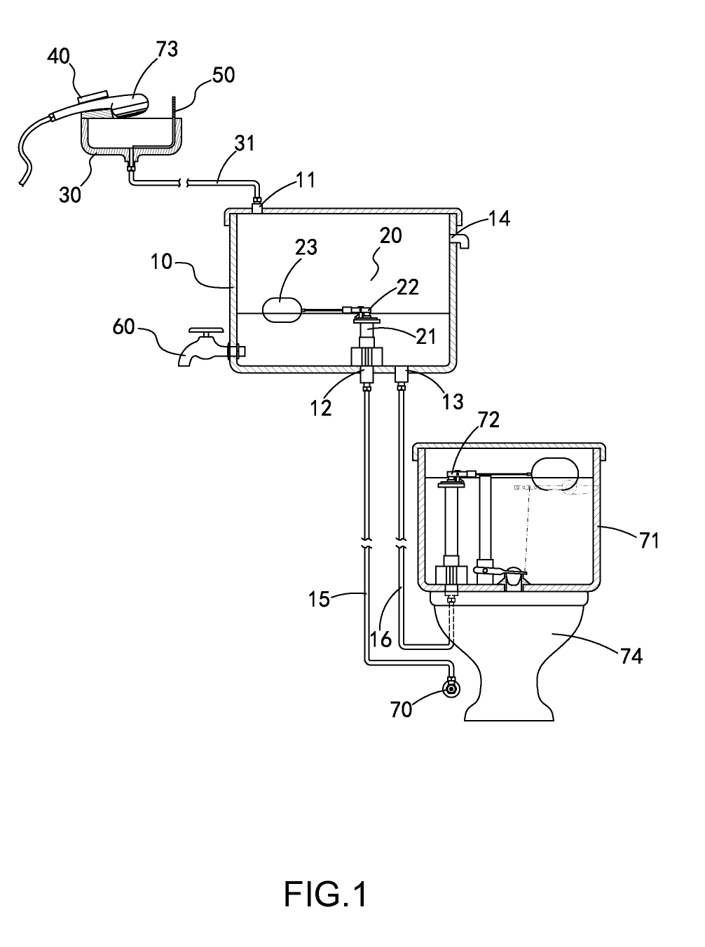

Referring now to FIG. 1, in which a water saving tank includes a tank box 10, a supplementary device 20, a water collection funnel 30, a clamping fixture 40, a temperature sensor 50, and a faucet 60.

The tank box 10 includes an inlet 11, a supplementary port 12, an outlet 13 and an overflow port 14. The inlet 11 is disposed at the top of the tank box 10. The supplementary port 12 is disposed at the bottom of the tank box 10 and connects to an exterior water source 70 via a pipe 15. The exterior water source 70 is a tap joint port. The outlet 13 is disposed at the bottom of the tank box 10 and connects to a fill mechanism 72 of a cistern 71 of a water closet 74 via a pipe 16. The position level of the tank box 10 is higher than that of the cistern 71. The overflow port 14 is disposed at a lateral side of the tank box 10 and adjacent to the top edge of the tank box 10.

The supplementary device 10 includes an inlet pipe 21, a water supply valve 22, and a float ball 23. The bottom end of the inlet pipe 21 connects the supplementary port 12, the water supply valve 22 joints with a top end of the inlet pipe 21 for controlling whether the water of the inlet 21 flows into the tank box 10. The float ball 23 connects the water supply valve 22 for switching the water supply valve 22. The supplementary device 20 could also use a buoy instead of the float boat to switch the water supply valve 22.

The water collection funnel 30 connects to the inlet 11 of the tank box 10 via a pipe 31. The position of the water collection funnel 30 is higher than that of the tank box 10.

The clamp fixture 40 is used for engaging a shower head 73 to a predetermined position for forwarding the water from the shower head 73 to water collection funnel 30.

The temperature sensor 50 is disposed to the water collection funnel 30 for detecting the temperature of the water from the shower head 73. The temperature sensor 50, in this case, is able to show the value or extent of the temperature by numbers, scales or colors.

The faucet 60 connects to a lateral side of the tank box 10 in a direct manner. The faucet 60 is adjacent to the bottom edge of the tank box 10, which means the faucet 60 should be lower than a second predetermined level, so that the water of the tank box 10 could be the water source of the faucet 60.

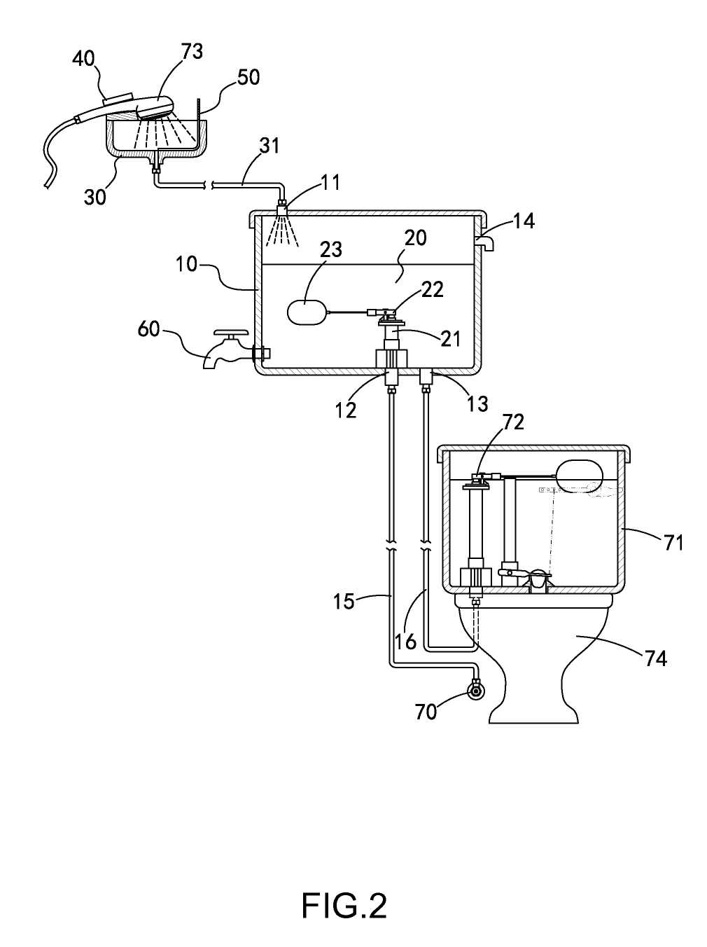

Please referring FIG. 2, the shower head 73 with running water could be hung on the clamp fixture 40 while using soap or shower gel or cleaning different parts, to break down the showering. The water of the shower head 73 runs into the water collection funnel 30 and flows into the tank box 10 via the pipe 31. Therefore, the tank box 10 could collect the water supposed to be wasted and further provide the resourced water for the cistern 71 or the faucet 60. The water is saved and further reserved for spared. In addition, the user could know the temperature of the water by the sensor 50, and it's more convenient to get the shower head in time. When the water level in the tank box 10 meets the overflow port 14, the water could be drained out via the overflow port 14 to keep the water level maximum.

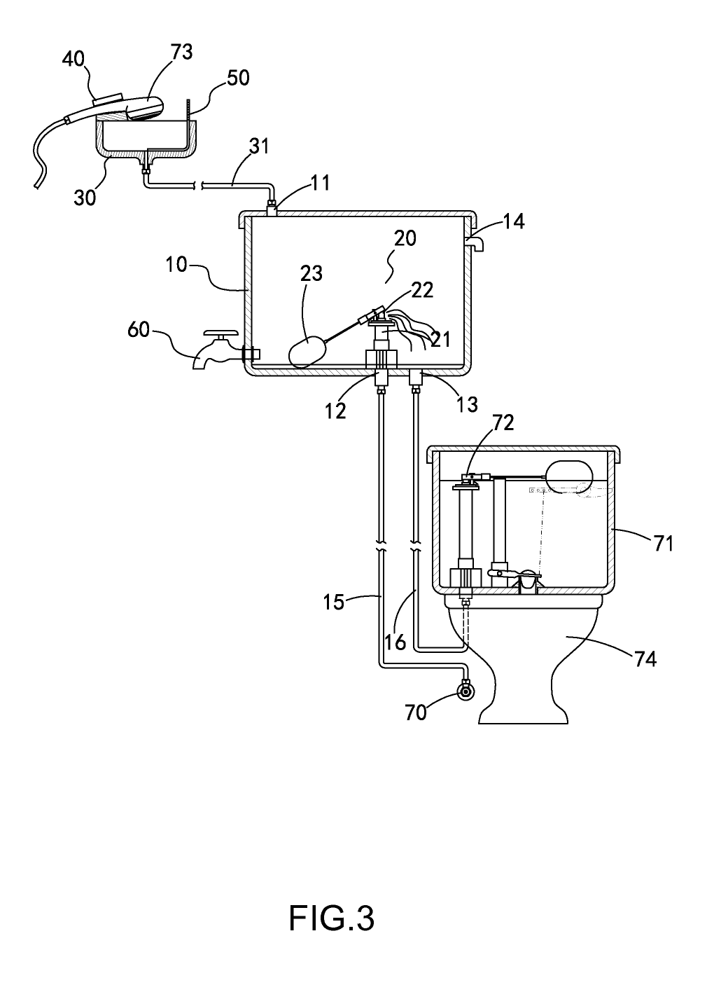

With respect to FIG. 3, the water from the tank box 10 flows out by the outlet 13 or the faucet 60, so that the water in the tank box 10 drops to a first predetermined water level. The float ball 23 of the supplementary device 20 descends by the water level so as to open the water supply valve 22, and the water from the inlet 21 is allowed to fill the tank box 10. When the water level is up to the second predetermined water level, as in FIG. 1, the float ball 23 of the supplementary device 20 ascends thereby and the water of the inlet 21 is blocked to flow into the tank box. Thus, the second predetermined water level is kept often so as to guarantee the water is enough for the cistern 71 or the faucet 60.

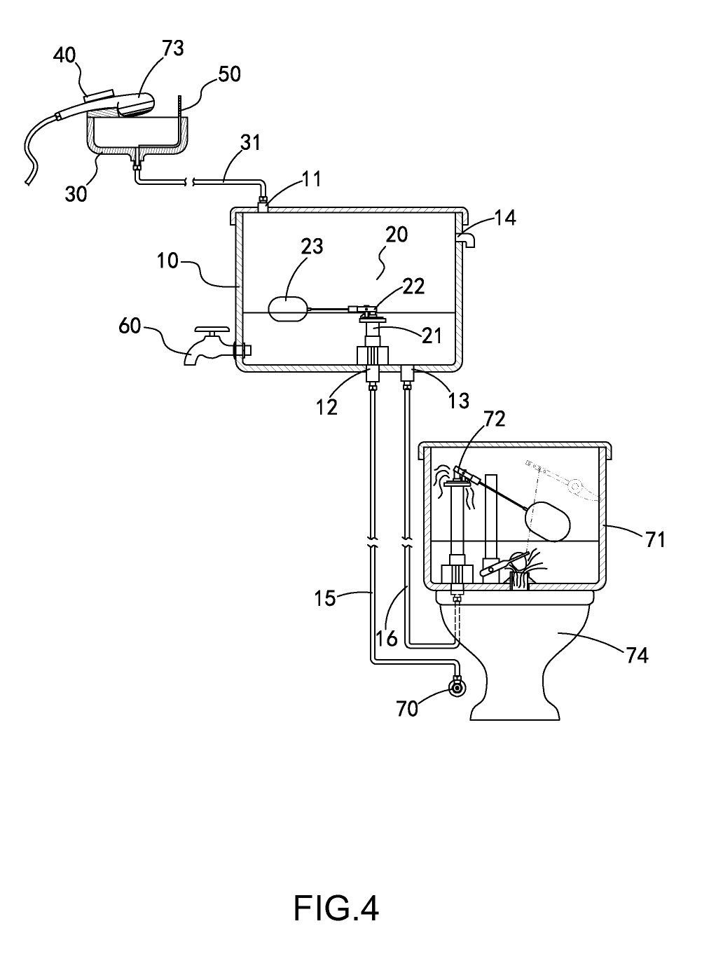

With respect to FIG. 4, when the water in the cistern 71 is drained into the bowl 74, the fill mechanism 72 would open to fill the cistern 71. The water of the tank box 10 fills into the cistern 71 via the outlet 13, the pipe 16 and the fill mechanism 72. When the water level of the cistern 71 is up to a certain level, the fill mechanism 72 closes to block the water filling from the tank box 10, as in FIG. 1.

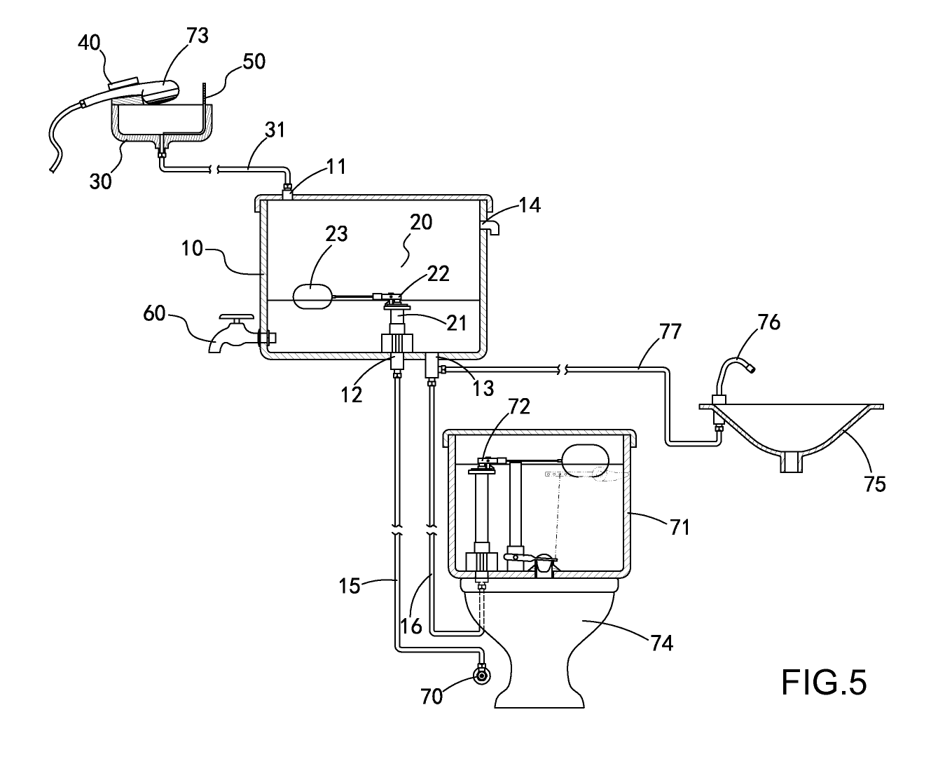

With respect to FIG. 5, a second embodiment of the water saving tank is disclosed. The configuration thereof is similar to that of the first embodiment, and the difference is the water of the tank box 10 could be a water resource of a sink 75. The position level of the sink 75 is lower than that of the tank box 10, and the faucet 76 of the sink 75 connects the tank box 10 by a pipe 77 connecting to the outlet 13.

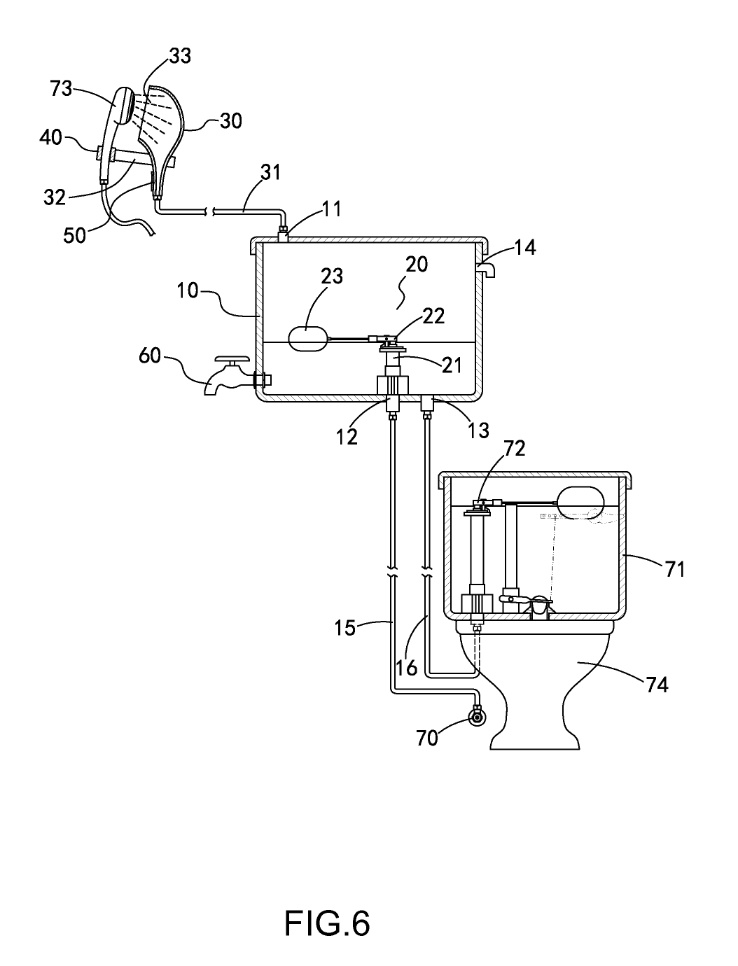

With respect to FIG. 6, a third embodiment of the water saving tank is disclosed. The configuration thereof is similar to that of the first embodiment, and the difference is that the clamp fixture 40 is the original hanging seat for engaging the shower head. The water collection funnel 30 combines to a lateral side of the clamp fixture 40 by a connection member 32. The water collection funnel 30 includes a water collection port 33 to collection water from the shower head 73. The temperature sensor 50 is disposed at the top of where the water collection funnel 30 connects to the pipe 31.

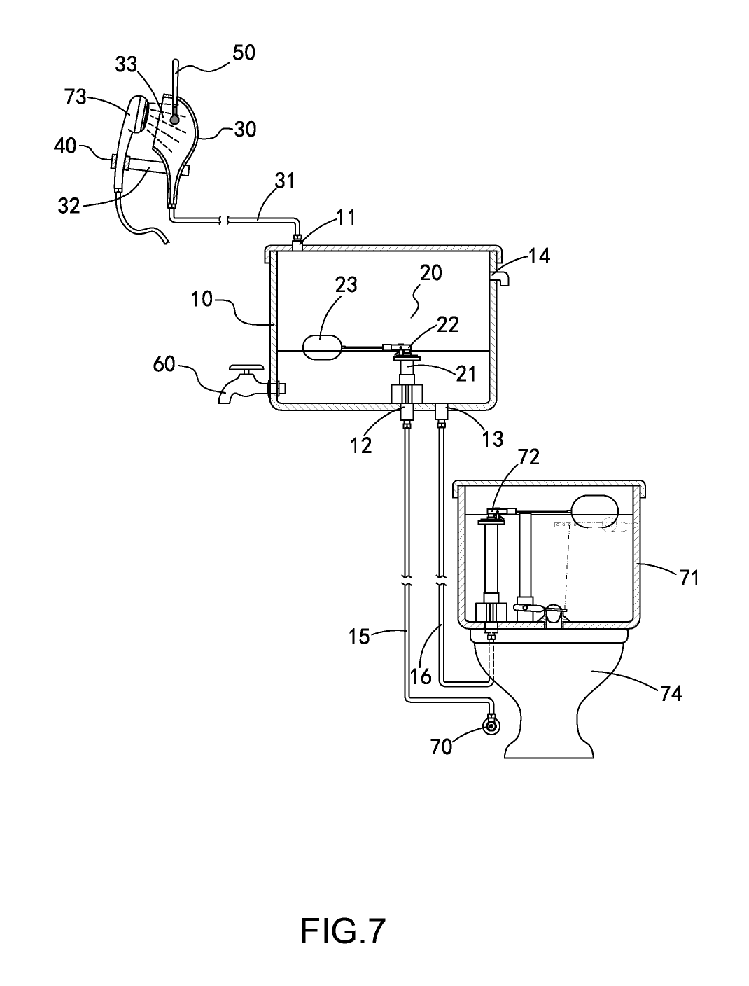

With respect to FIG. 7, a fourth embodiment of the water saving tank is disclosed. The configuration thereof is similar to that of the third embodiment, and the difference is that the temperature sensor 50 extends into the water collection funnel 30 and in the interior of the water collection port 33. The part to show the value of temperature of the temperature sensor 50 reveals outside the water collection funnel 30.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A water saving tank comprising:
a tank box, including an inlet, a supplementary port and an outlet; the inlet collecting the water from a shower head, the supplementary port connecting to an exterior water source, and the outlet connecting to a fill device in a cistern of a water closet; a position level of the tank box is higher than that of the cistern of the water closet; and
a supplementary device jointing to the supplementary port; as the water in the tank box drops to a first predetermined water level, the water of the exterior water source flows into the tank box; as the water in the tank box is filled up to a second predetermined water level, the water of the exterior water source is blocked to flow into the tank box.

2. The water saving tank according to claim 1, further including a water collection funnel and a clamping fixture; the water collection funnel connecting to the inlet of the tank box; the clamping fixture engaging the shower head to a predetermined position for forwarding the water from the shower head to water collection funnel.

3. The water saving tank according to claim 2, further including a temperature sensor, which is disposed to the water collection funnel for detecting the temperature of the water from the shower head.

4. The water saving tank according to claim 1, wherein the supplementary device includes a inlet pipe, a water supply valve, and a float ball; a bottom end of the inlet pipe connects the supplementary port, the water supply valve joints with a top end of the inlet pipe for controlling whether the water of the inlet flows into the tank box; the float ball connects the water supply valve for switching the water supply valve.

5. The water saving tank according to claim 4, further including a faucet connecting to the tank box; wherein a position level of the faucet is lower than that of the second predetermined water level so that the water in the tank box is taken as the source of the faucet

6. The water saving tank according to claim 5, wherein the faucet connects the tank box in a direct manner; and the faucet is adjacent to a bottom edge of the tank box.

7. The water saving tank according to claim 5, wherein the faucet is disposed on a sink and connects the tank box via a pipe, and a position level of the tank box is higher than that of the sink.

8. The water saving tank according to claim 7, wherein the pipe of the faucet connects the outlet of the tank box.

9. The water saving tank according to claim 4, wherein the tank box includes an overflow port, which is adjacent to a top edge of a lateral side of the tank box.

10. The water saving tank according to claim 2, wherein the supplementary device includes a inlet pipe, a water supply valve, and a float ball; a bottom end of the inlet pipe connects the supplementary port, the water supply valve joints with a top end of the inlet pipe for controlling whether the water of the inlet flows into the tank box; the float ball connects the water supply valve for switching the water supply valve.

11. The water saving tank according to claim 10, further including a faucet connecting to the tank box; wherein a position level of the faucet is lower than that of the second predetermined water level so that the water in the tank box is taken as the source of the faucet

12. The water saving tank according to claim 11, wherein the faucet connects the tank box in a direct manner; and the faucet is adjacent to a bottom edge of the tank box.

13. The water saving tank according to claim 11, wherein the faucet is disposed on a sink and connects the tank box via a pipe, and a position level of the tank box is higher than that of the sink.

14. The water saving tank according to claim 13, wherein the pipe of the faucet connects the outlet of the tank box.

15. The water saving tank according to claim 10, wherein the tank box includes an overflow port, which is adjacent to a top edge of a lateral side of the tank box.

16. The water saving tank according to claim 3, wherein the supplementary device includes a inlet pipe, a water supply valve, and a float ball; a bottom end of the inlet pipe connects the supplementary port, the water supply valve joints with a top end of the inlet pipe for controlling whether the water of the inlet flows into the tank box; the float ball connects the water supply valve for switching the water supply valve.

17. The water saving tank according to claim 3, further including a faucet connecting to the tank box; wherein a position level of the faucet is lower than that of the second predetermined water level so that the water in the tank box is taken as the source of the faucet

18. The water saving tank according to claim 16, wherein the faucet connects the tank box in a direct manner; and the faucet is adjacent to a bottom edge of the tank box.

19. The water saving tank according to claim 17, wherein the faucet is disposed on a sink and connects the tank box via a pipe, and a position level of the tank box is higher than that of the sink.

20. The water saving tank according to claim 17, wherein the pipe of the faucet connects the outlet of the tank box.

21. The water saving tank according to claim 16, wherein the tank box includes an overflow port, which is adjacent to a top edge of a lateral side of the tank box.
